(19) United States
(12) Patent Application Publication
(10) Pub. No.: US 2014/0180768 A1
(43) Pub. Date: Jun. 26, 2014

(54) EVALUATION OF PROPOSED ENTERPRISE PLAN

(71) Applicant: John Hack, Maplewood, NJ (US)

(72) Inventor: John Hack, Maplewood, NJ (US)

(21) Appl. No.: 13/721,700

(22) Filed: Dec. 20, 2012

(51) Int. Cl. G06Q 10/06

(52) U.S. Cl. CPC G06Q 10/0637
USPC 705/7.36

(57) ABSTRACT

A system includes identification of a first plurality of variables of a plan, the plan comprising budgeted values for the first plurality of variables and for a second plurality of other variables of the plan, and, for each of the first plurality of variables, determination of a first correlation with each of the second plurality of other variables of the plan based on historical values of the first plurality of variables and of the second plurality of variables, determination of a second correlation with each of the second plurality of other variables based on the budgeted values of the first plurality of variables and the second plurality of variables, and comparison of the first correlations with respective ones of the second correlations. A visualization is generated to illustrate one or more of the correlation comparisons.

### BACKGROUND

Enterprises use budgets, resource plans and the like to anticipate and prepare for future operations. These items, which will generally be referred to as plans, typically include complex sets of interrelated variables, as well as values assigned to each variable for one or more time periods.

Plans may be generated manually and/or via statistical forecasting, which uses time-series analysis to extrapolate current trends forward. Statistical forecasting assumes that underlying conditions are static or follow a known pattern. Accordingly, a planner may generate a statistical forecast and then modify the forecast to account for anticipated changes in underlying assumptions and strategy. Regardless of how plans are generated, their dependability is difficult to gauge.

### BRIEF DESCRIPTION OF THE DRAWINGS

FIG. 1 is a block diagram of a system according to some embodiments.

FIG. 2 is a flow diagram of a process according to some embodiments.

FIG. 3 illustrates calculation of correlations in historical data according to some embodiments.

FIG. 4 is a graphical representation of historical data of an example according to some embodiments.

FIG. 5 illustrates calculation of correlations in plan data according to some embodiments.

FIG. 6 is a visualization of correlation comparisons according to some embodiments.

FIG. 7 is a flow diagram of a process according to some embodiments.

FIG. 8 is a visualization of correlation comparisons according to some embodiments.

FIG. 9 is a block diagram of an apparatus according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

Generally, some embodiments allow a user to identify first underlying relationships within historical data, identify second underlying relationships within plan data, and compare the first underlying relationships with the second underlying relationships. Some embodiments may therefore allow a user to determine whether the budgeted plan is realistic, in view of historical data. Some embodiments may provide an automatic determination as to whether the budgeted plan is realistic.

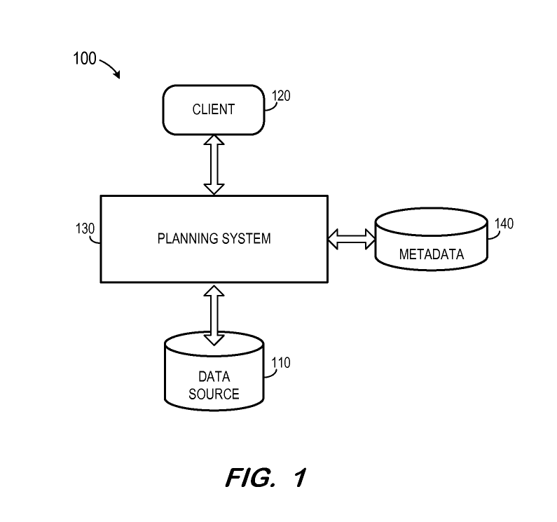

FIG. 1 is a block diagram of system 100 according to some embodiments. System 100 includes data source 110, client 120, and planning system 130. Data source 110 may comprise any query-responsive data source or sources that are or become known. Data source 110 may comprise a relational database, a multi-dimensional database, an eXtendable Markup Language (XML) document, or any other data storage system storing structured and/or unstructured data. The data of data source 110 may be distributed among several relational databases, multi-dimensional databases, and/or other data sources. Embodiments are not limited to any number or types of data sources. For example, data source 110 may comprise one or more OnLine Analytical Processing (OLAP) databases, spreadsheets, text documents, presentations, etc.

In some embodiments, data source 110 is implemented in Random Access Memory (e.g., cache memory for storing recently-used data) and one or more fixed disks (e.g., persistent memory for storing the full database). Alternatively, data source 110 may implement an “in-memory” database, in which volatile (e.g., non-disk-based) memory (e.g., Random Access Memory) is used both for cache memory and for storing the full database. In some embodiments, the data of data source 110 may comprise one or more of row-based tabular data stored in row format, column-based tabular data stored in columnar format, and object-based data. Data source 110 may also or alternatively support multi-tenancy by providing multiple logical database systems which are programmatically isolated from one another. Moreover, the data of data source 110 may be indexed and/or selectively replicated in an index to allow fast searching and retrieval thereof

The data stored in data source 110 may be generated by planning system 130 and/or received from one or more disparate data sources. These data sources may include data warehouses and sources of enterprise data, including but not limited to accounting, human resources and operations backend systems.

Planning system 130 generally provides data of data source 110 to reporting clients, such as client 120, in response to instructions (e.g., MultiDimensional eXpressions statements or Structured Query Language statements) received therefrom. Planning system 130 may provide analysis and/or forecasting functionality based on the data of data source 110.

Client 120 may comprise one or more devices executing program code of a software application for presenting user interfaces to allow interaction with planning system 130. Presentation of a user interface may comprise any degree or type of rendering, depending on the type of user interface code generated by planning system 130. For example, client 120 may execute a Web Browser to receive a Web page (e.g., in HTML format) from planning system 130, and may render and present the Web page according to known protocols. Client 120 may also or alternatively present user interfaces by executing a standalone executable file (e.g., an .exe file) or code (e.g., a JAVA applet) within a virtual machine.

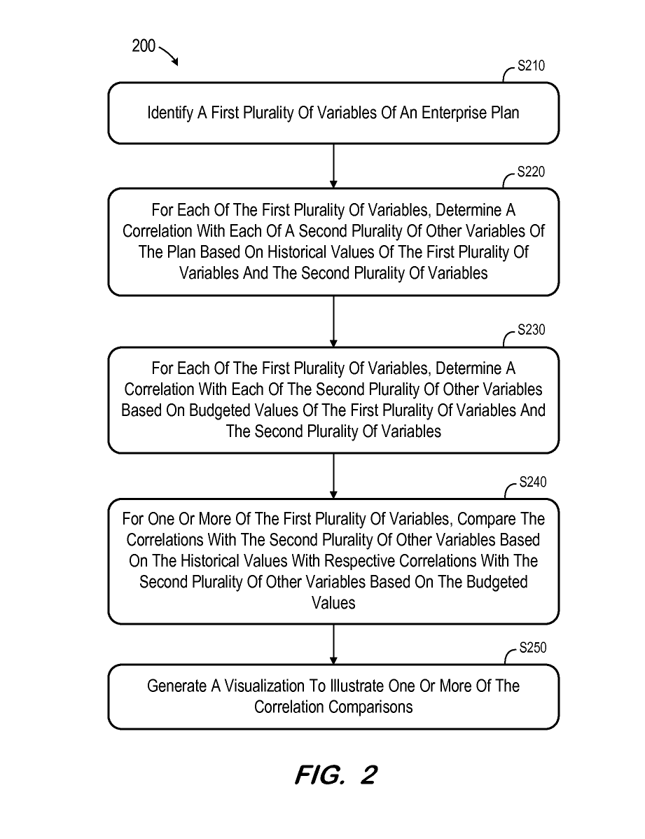

FIG. 2 comprises a flow diagram of process 200 according to some embodiments. In some embodiments, various hardware elements of planning system 130 execute program code to perform process 200. Process 200 and all other processes mentioned herein may be embodied in processor-executable program code read from one or more of non-transitory computer-readable media, such as a floppy disk, a CD-ROM, a DVD-ROM, a Flash drive, and a magnetic tape, and then stored in a compressed, uncompiled and/or encrypted format. In some embodiments, hard-wired circuitry may be used in place of, or in combination with, program code for implementation of processes according to some embodiments. Embodiments are therefore not limited to any specific combination of hardware and software.

Initially, at 5210, a first plurality of variables of an enterprise plan are identified. The plan may comprise any set of interrelated variables and values assigned to those variables. One or more of the variables may be associated with a distinct value for each of two or more time periods.

In some embodiments, the plan is a budget, such as a forecast of revenue and expenditure. Such a budget may include budget items (i.e., variables), with each budget item being assigned a value for each of successive time periods (e.g., months in a following fiscal year).

The first plurality of variables identified at S210 may comprise variables which have been deemed useful to track. These variables may be those based on which the performance of the enterprise is evaluated (e.g., Profit, Units Sold, Revenue). The first plurality of variables will be referred to herein as Key Performance Indicators (KPIs).

For each of the first plurality of variables, a correlation with each of a second plurality of the variables of the plan is determined at S220. The correlations are determined based on historical values of the first plurality of variables and the second plurality of variables.

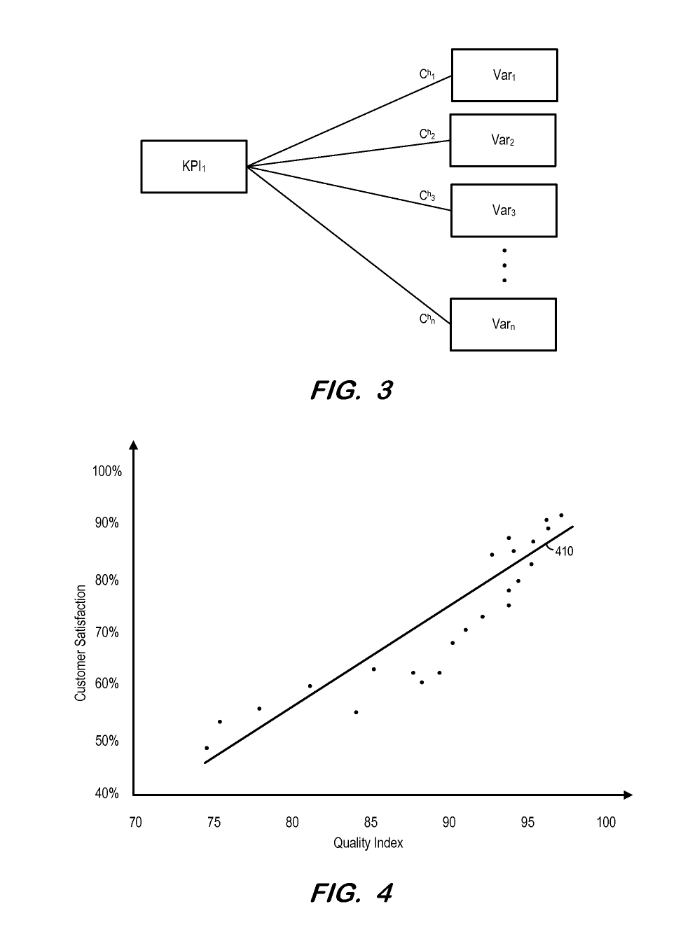

FIG. 3 illustrates a subset of the correlations determined at S220. Specifically, KPI₁ represents one of the first plurality of variables (e.g., Revenue) identified at S210. Additional variables of the first plurality of variables, including some or all of the key performance measures of the plan, may be represented as KPI₂ to KPIₘ. Var₁ to Varₙ represent, respectively, other variables of the enterprise plan (e.g., headcount, average price). Var₁ to Varₙ may represent all or a subset of the variables in the plan.

Correlations C^{h}₁ to C^{h}ₙ represent correlations determined between KPI₁ and each respective variable Var₁ to Varₙ. The superscript “h” indicates that the correlations are based on historical data. FIG. 3 illustrates correlations determined at S220 for one of the first plurality of variables identified at S210, therefore S220 further comprises determining correlations as illustrated in FIG. 3 for each other of the first plurality of variables.

Each correlation may be determined using any system to determine and characterize correlation between two data sets that is or becomes known. FIG. 4 illustrates one example of determining a correlation between the variables Quality Index and Customer Satisfaction according to some embodiments. It will be assumed that Customer Satisfaction is one of the first plurality of variables determined at S210 (i.e., the KPI).

In this regard, each plotted point of FIG. 4 is associated with a Quality Index value and a corresponding Customer Satisfaction value. Values which are deemed “corresponding” may be associated with the same or different time periods. In some instances, a plotted point indicates a Quality Index value associated with a given time period (e.g., Feb 2012) and a Customer Satisfaction value associated with the same time period (e.g., Feb 2012). In other instances, the time periods associated with a single plotted point may differ to reflect leading and lagging relationships between the variables. For example, a plotted point may indicates a Quality Index value associated with a given time period (e.g., Feb 2012) and a Customer Satisfaction value associated with a later time period (e.g., Apr 2012).

According to some embodiments, the determined correlation is based on the parameters of a function that best fits the data. In some embodiments, the determined correlation is based on the equation governing “best-fit” line 410. This equation may be represented as:

y=α+βx+ε

where α is the constant coefficient, β is the linear coefficient, and ε is the residual portion. In some embodiments, the correlation is generally represented by the values of α and β. In some embodiments, the correlation is generally represented by the values of α and β plus a value describing the fit of the function to the data. For example, the Pearson Correlation Coefficient is used in some embodiments to describe the fit of the function to the data. In some embodiments, a Coefficient of Determination R² may also be determined for each correlation at S220, to describe how well the “best-fit” lines fit the plotted values.

Non-exhaustive examples of other functions for determining any correlations described herein include log-linear, log-log-linear, and polynomial fit.

Next, at S230, correlations with each of the second plurality of the variables are again determined for each of the first plurality of variables. However, the correlations are determined based on budgeted values of the first plurality of variables and the second plurality of variables. In other words, the correlations are determined at S220 based on “actual” data, and the correlations are determined at S230 based on “plan” data.

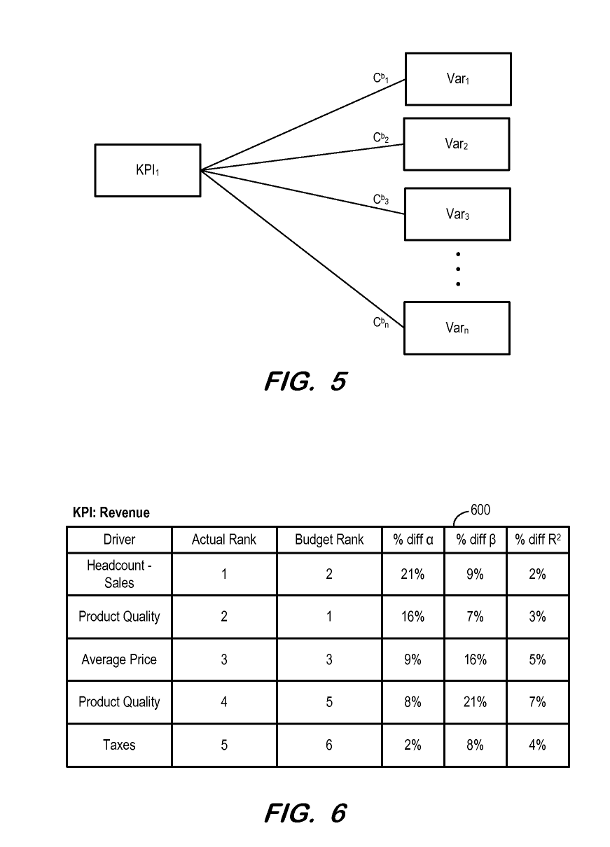

FIG. 5 illustrates correlations determined at S230 for KPI₁. Again, KPI₁ represents one of the first plurality of variables identified at S210. Var₁ to Varₙ again represent other variables of the enterprise plan.

Correlations C^{b}₁ to C^{b}ₙ represent correlations determined between KPI₁ and each respective variable Var₁ to Varₙ, with the superscript “b” indicating that the correlations are based on budgeted data. S230 further comprises determining correlations as illustrated in FIG. 5 for each other of the first plurality of variables.

The correlations may be determined at S230 in a similar manner as determined at S220. With respect to the example of S220 described above, the enterprise plan may include, for each of several time periods, budgeted values for each of its variables. For each of the first plurality of variables, values are plotted with corresponding values (from same, lagging or leading time periods) of another variable and α, β and R² may be determined from a best-fit line as shown in FIG. 4. In some embodiments, some of the variables of the plan are transformed so as to work with best-fit lines. For example, by applying a logarithmic transformation such that data modeled by an exponential, power, and the like may be modeled by a line.

At S240, and for each of the first plurality of variables, the correlations determined at S220 are compared with respective ones of the correlations determined at S230. With reference to FIGS. 3 and 5, S240 may comprise comparing each of C^{h}₁ through C^{h}ₙ with respective ones of C^{b}₁ through C^{b}ₙ. These comparisons relate only to KPI₁; similar comparisons occur for each other of the first plurality of variables.

In more detail, correlation C^{h}₃ is compared with correlation C^{b}₃ at S240. Such a comparison may indicate whether the relationship between values of KPI₁ and Var₃ in the budgeted plan is similar to the relationship between values KPI₁ and Var₃ in the actual (historical) data.

The correlations may be compared at S240 using any system for comparing two data sets that is or becomes known. For example, the α, β and R² values of one historical correlation (e.g., C^{h}₃) may be compared with the α, β and R² values of its corresponding “budgeted” correlation (e.g., C^{b}₃). These comparisons may comprise determining the percentage differences between the corresponding α, β and R² values.

A visualization is then generated at S250 to illustrate one or more of the correlation comparisons of S240. The visualization may comprise any perceptible indication of one or more of the correlation comparisons. Visualizations according to some embodiments include, but are not limited to, tables, charts, text, icons (e.g., flags) and the like.

FIG. 6 illustrates a visualization generated according to some embodiments of S250, but embodiments are not limited thereto. Visualization 600 is associated only with one of the first plurality of variables identified at S210 (i.e., the KPI Revenue). A visualization such as visualization 600 may be generated at S250 for each other one of the first plurality of variables. The format and content of the generated visualization may depend upon the type of comparison performed at 5240 and the information produced by such a comparison.

The Driver column of FIG. 6 lists plan variables corresponding to Var₁ through Varₙ of FIGS. 3 and 5. The Actual rank column ranks each Driver in terms of its degree of correlation with KPI Revenue, as calculated based on historical data at S220. Similarly, the Budget rank column ranks each Driver in terms of its degree of correlation with KPI Revenue as calculated based on budget data at S230. Finally, the remaining three “% diff” columns indicate the percentage differences between the α, β and R² values of a Driver's historical correlation with KPI Revenue, and the α, β and R² values of the Driver's budgeted correlation with KPI Revenue. Some embodiments may also or alternatively present absolute differences between the values.

Of course, the correlation-related columns of visualization 600 are dependent upon the type of the determined correlation. For example, visualization 600 may include other measures of “quality of fit” for either linear (e.g., Student's t-statistic, F-Statistic) or non-linear relationships.

The Drivers shown in visualization 600 may be selected so as to only include the five (or any other number) Drivers which are most correlated with KPI Revenue. According to some embodiments, Drivers for which the correlation is deemed “too” high are filtered out of the generated visualization because their inclusion would not be particularly illustrative. For example, Net Income will typically be highly correlated with

Revenue because Revenue is a significant component of Net Income, but such a high correlation within a budget's data might not be particularly indicative of the level to which the budget conforms to underlying relationships in corresponding historical data.

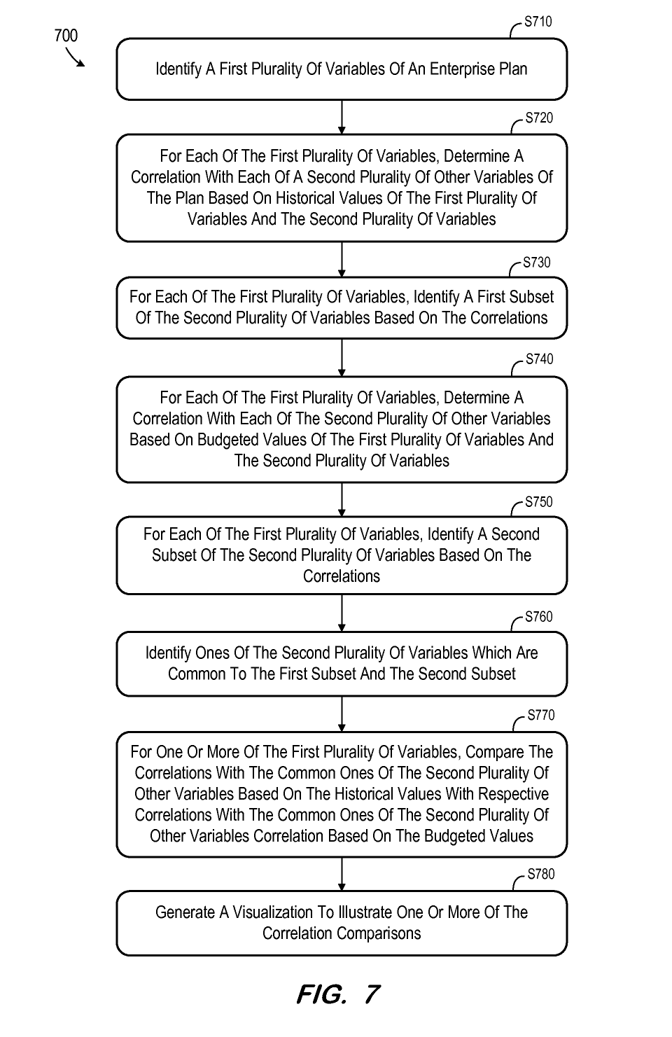

FIG. 7 illustrates process 700, which may comprise an implementation of process 200 according to some embodiments. S710 and S720 proceed as described above. At S730, a first subset of the second plurality of variables is identified for each of the first plurality of variables based on the correlations determined at S720. For each one of the first plurality of variables, the first subset may include the top M (e.g., 20) of the second plurality of variables, ranked by their degree of correlation with the one of the first plurality of variables. As described above, any of the second plurality of variables which are too highly correlated with one of the first plurality of variables might not be included in the first subset determined for the one of the first plurality of variables.

S740 proceeds as described above with respect to S230, and S750 proceeds similarly to S730, but to identify a second subset of the second plurality of variables for each of the first plurality of variables based on the correlations determined at S740. Accordingly, the first subset of the second plurality of variables is identified based on correlations in historical data, while the second subset of the second plurality of variables is identified based on correlations in budgeted data.

Next, S760 includes identification of ones of the second plurality of variables which are common to the first subset and the second subset. S770 then proceeds similarly to S240 of process 200, but with respect only to the common ones of the second plurality of variables. That is, for each of the first plurality of variables, the correlations determined at S720 are compared with respective ones of the correlations determined at S740, but only for the common ones of the second plurality of variables.

The comparisons may proceed at S770 in any known manner for comparing data sets. In some embodiments, and for each comparison, a correlation determined at S720 is treated as “normative” and S770 comprises determining the likelihood that a corresponding correlation determined at S740 exhibits a relationship with the normative correlation. This determination may employ statistical techniques such as but not limited to Student's T-Test and F-Test.

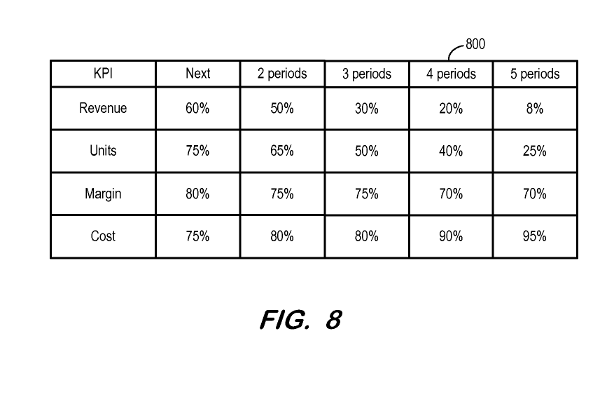

A visualization is generated at S780 to illustrate one or more of the correlation comparisons. FIG. 8 illustrates a generated visualization according to some embodiments. Visualization 800 illustrates likelihoods which may have been determined as described with respect to S770. More particularly, the Next column represents the overall likelihood that budget-derived correlations will exhibit a relationship with corresponding historical-derived correlations for a given KPI. “Next” indicates that the correlations which were compared to calculate the likelihoods of this column were determined using a one period lag between the corresponding KPI values and the values of the second plurality of variables. With respect to FIG. 4, this means that each plotted point corresponds to a KPI value for a given month and a variable value for the immediately prior month. Consequently, the correlations underlying the likelihoods represented by the “X periods” columns were determined using an X period lag between the corresponding KPI values and the values of the second plurality of variables.

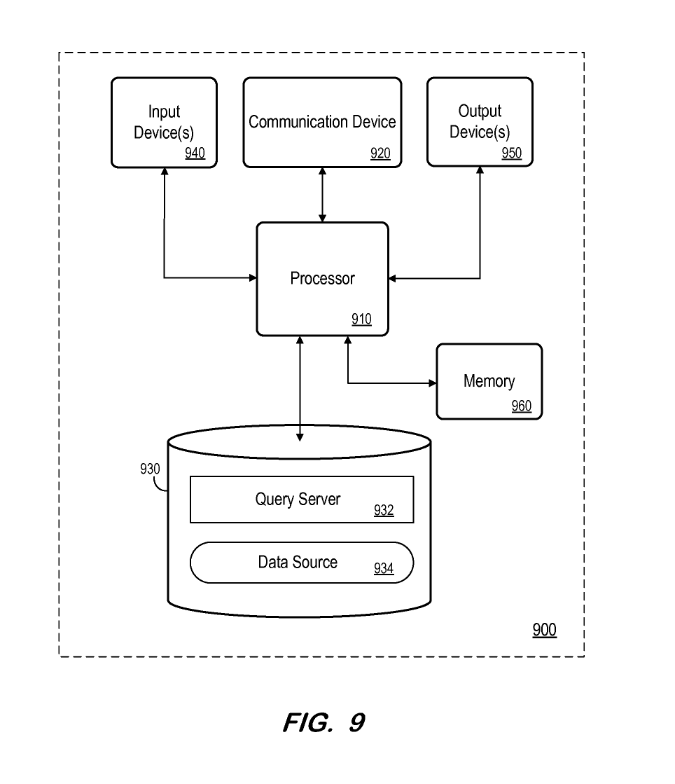

FIG. 9 is a block diagram of apparatus 900 according to some embodiments. Apparatus 900 may comprise a general-purpose computing apparatus and may execute program code to perform any of the processes described herein. Apparatus 900 may comprise an implementation of planning system 130 and data source 110, or of the entirety of system 100. Apparatus 900 may include other unshown elements according to some embodiments.

Apparatus 900 includes processor 910 operatively coupled to communication device 920, data storage device 930, one or more input devices 940, one or more output devices 950 and memory 960. Communication device 920 may facilitate communication with external devices, such as a reporting client, or a data storage device. Input device(s) 940 may comprise, for example, a keyboard, a keypad, a mouse or other pointing device, a microphone, knob or a switch, an infra-red (IR) port, a docking station, and/or a touch screen. Input device(s) 940 may be used, for example, to enter information into apparatus 900. Output device(s) 950 may comprise, for example, a display (e.g., a display screen) a speaker, and/or a printer.

Data storage device 930 may comprise any appropriate persistent storage device, including combinations of magnetic storage devices (e.g., magnetic tape, hard disk drives and flash memory), optical storage devices, Read Only Memory (ROM) devices, etc., while memory 960 may comprise Random Access Memory (RAM).

Planning system 932 may comprise program code executed by processor 910 to cause apparatus 900 to perform any one or more of the processes described herein. Embodiments are not limited to execution of these processes by a single apparatus. Data source 934 may implement data source 110 as described above. As also described above, data source 110 may be implemented in volatile memory such as memory 960. Data storage device 930 may also store data and other program code for providing additional functionality and/or which are necessary for operation of apparatus 900, such as device drivers, operating system files, etc.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may comprise any number of hardware and/or software elements suitable to provide the functions described herein as well as any other functions. For example, any computing device used in an implementation of system 100 may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing processor-executable program code; and
a processor to execute the processor-executable program code in order to cause the computing device to:
identify a first plurality of variables of a plan, the plan comprising budgeted values for the first plurality of variables and for a second plurality of other variables of the plan;
for each of the first plurality of variables, determine a first correlation with each of the second plurality of other variables of the plan based on historical values of the first plurality of variables and of the second plurality of variables;
for each of the first plurality of variables, determine a second correlation with each of the second plurality of other variables based on the budgeted values of the first plurality of variables and the second plurality of variables;
for each of the first plurality of variables, compare the first correlations with respective ones of the second correlations; and
generate a visualization to illustrate one or more of the correlation comparisons.

2. A system according to claim 1, wherein determination, for each of the first plurality of variables, of the first correlation with each of the second plurality of other variables of the plan comprises determining a constant coefficient and a linear coefficient for each of the first correlations,
wherein determination, for each of the first plurality of variables, of the second correlation with each of the second plurality of other variables of the plan comprises determining a constant coefficient and a linear coefficient for each of the second correlations, and
wherein comparison of the first correlations with respective ones of the second correlations comprises comparing the constant coefficient and the linear coefficient of the first correlations with the constant coefficient and the linear coefficient of respective ones of the second correlations.

3. A system according to claim 1, wherein comparison of the first correlations with respective ones of the second correlations comprises determining a likelihood that each of the first correlations exhibits a relationship with a respective one of the second correlations.

4. A system according to claim 1, wherein the processor is to further execute the processor-executable program code in order to cause the computing device to:
identify, for each of the first plurality of variables, a first subset of the second plurality of other variables based on the first correlations;
identify, for each of the first plurality of variables, a second subset of the second plurality of other variables based on the second correlations; and
identify ones of the second plurality of other variables which are common to the first subset and to the second subset,
wherein comparison of the first correlations with respective ones of the second correlations comprises comparison of the first correlations with each of the common ones of the second plurality of other variables with the second correlations with each of the common ones of the second plurality of other variables.

5. A system according to claim 1,
wherein determination of a first correlation with each of the second plurality of other variables of the plan based on historical values of the first plurality of variables and of the second plurality of variables comprises determination of a first correlation with each of the second plurality of other variables of the plan based on historical values of the first plurality of variables associated with a first time period and of the second plurality of variables associated with a second time period, and
wherein determination of a second correlation with each of the second plurality of other variables of the plan based on budgeted values of the first plurality of variables and of the second plurality of variables comprises determination of a second correlation with each of the second plurality of other variables of the plan based on budgeted values of the first plurality of variables associated with the first time period and of the second plurality of variables associated with the second time period.

6. A non-transitory computer-readable medium storing program code, the program code executable by a processor of a computing system to cause the computing system to:
identify a first plurality of variables of a plan, the plan comprising budgeted values for the first plurality of variables and for a second plurality of other variables of the plan;
for each of the first plurality of variables, determine a first correlation with each of the second plurality of other variables of the plan based on historical values of the first plurality of variables and of the second plurality of variables;
for each of the first plurality of variables, determine a second correlation with each of the second plurality of other variables based on the budgeted values of the first plurality of variables and the second plurality of variables;
for each of the first plurality of variables, compare the first correlations with respective ones of the second correlations; and
generate a visualization to illustrate one or more of the correlation comparisons.

7. A medium according to claim 6, wherein determination, for each of the first plurality of variables, of the first correlation with each of the second plurality of other variables of the plan comprises determining a constant coefficient and a linear coefficient for each of the first correlations,
wherein determination, for each of the first plurality of variables, of the second correlation with each of the second plurality of other variables of the plan comprises determining a constant coefficient and a linear coefficient for each of the second correlations, and
wherein comparison of the first correlations with respective ones of the second correlations comprises comparing the constant coefficient and the linear coefficient of the first correlations with the constant coefficient and the linear coefficient of respective ones of the second correlations.

8. A medium according to claim 6, wherein comparison of the first correlations with respective ones of the second correlations comprises determining a likelihood that each of the first correlations exhibits a relationship with a respective one of the second correlations.

9. A medium according to claim 6, wherein the program code is further executable by a processor of a computing system to cause the computing system to:
identify, for each of the first plurality of variables, a first subset of the second plurality of other variables based on the first correlations;
identify, for each of the first plurality of variables, a second subset of the second plurality of other variables based on the second correlations; and
identify ones of the second plurality of other variables which are common to the first subset and to the second subset,
wherein comparison of the first correlations with respective ones of the second correlations comprises comparison of the first correlations with each of the common ones of the second plurality of other variables with the second correlations with each of the common ones of the second plurality of other variables.

10. A medium according to claim 6,
wherein determination of a first correlation with each of the second plurality of other variables of the plan based on historical values of the first plurality of variables and of the second plurality of variables comprises determination of a first correlation with each of the second plurality of other variables of the plan based on historical values of the first plurality of variables associated with a first time period and of the second plurality of variables associated with a second time period, and
wherein determination of a second correlation with each of the second plurality of other variables of the plan based on budgeted values of the first plurality of variables and of the second plurality of variables comprises determination of a second correlation with each of the second plurality of other variables of the plan based on budgeted values of the first plurality of variables associated with the first time period and of the second plurality of variables associated with the second time period.

11. A computer-implemented method comprising:
identifying a first plurality of variables of a plan, the plan comprising budgeted values for the first plurality of variables and for a second plurality of other variables of the plan;
for each of the first plurality of variables, determining a first correlation with each of the second plurality of other variables of the plan based on historical values of the first plurality of variables and of the second plurality of variables;
for each of the first plurality of variables, determining a second correlation with each of the second plurality of other variables based on the budgeted values of the first plurality of variables and the second plurality of variables;
for each of the first plurality of variables, comparing the first correlations with respective ones of the second correlations; and
generating a visualization to illustrate one or more of the correlation comparisons.

12. A method according to claim 11, wherein determining, for each of the first plurality of variables, of the first correlation with each of the second plurality of other variables of the plan comprises determining a constant coefficient and a linear coefficient for each of the first correlations,
wherein determining, for each of the first plurality of variables, of the second correlation with each of the second plurality of other variables of the plan comprises determining a constant coefficient and a linear coefficient for each of the second correlations, and
wherein comparing the first correlations with respective ones of the second correlations comprises comparing the constant coefficient and the linear coefficient of the first correlations with the constant coefficient and the linear coefficient of respective ones of the second correlations.

13. A method according to claim 11, wherein comparing the first correlations with respective ones of the second correlations comprises determining a likelihood that each of the first correlations exhibits a relationship with a respective one of the second correlations.

14. A method according to claim 11, further comprising:
identifying, for each of the first plurality of variables, a first subset of the second plurality of other variables based on the first correlations;
identifying, for each of the first plurality of variables, a second subset of the second plurality of other variables based on the second correlations; and
identifying ones of the second plurality of other variables which are common to the first subset and to the second subset,
wherein comparing the first correlations with respective ones of the second correlations comprises comparing the first correlations with each of the common ones of the second plurality of other variables with the second correlations with each of the common ones of the second plurality of other variables.

15. A method according to claim 11,
wherein determining a first correlation with each of the second plurality of other variables of the plan based on historical values of the first plurality of variables and of the second plurality of variables comprises determination of a first correlation with each of the second plurality of other variables of the plan based on historical values of the first plurality of variables associated with a first time period and of the second plurality of variables associated with a second time period, and
wherein determining a second correlation with each of the second plurality of other variables of the plan based on budgeted values of the first plurality of variables and of the second plurality of variables comprises determination of a second correlation with each of the second plurality of other variables of the plan based on budgeted values of the first plurality of variables associated with the first time period and of the second plurality of variables associated with the second time period.
